(19) United States
(12) Patent Application Publication
(10) Pub. No.: US 2008/0095037 A1
(43) Pub. Date: Apr. 24, 2008

(54) APPARATUS AND METHOD FOR COMMUNICATING CONTROL INFORMATION IN BROADBAND WIRELESS ACCESS SYSTEM

(75) Inventors: Young-Bin CHANG, Anyang-si (KR); Hyun-Jeong Kang, Seoul (KR); Chang-Yoon Oh, Yongin-si (KR); Jae-Weon Cho, Suwon-si (KR); Hyoung-Kyu Lim, Seoul (KR); Sung-Jin Lee, Seoul (KR); Yeong-Moon Son, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/875,333

(22) Filed: Oct. 19, 2007

(30) Foreign Application Priority Data
Oct. 20, 2006 (JP) 2006-0102471

(51) Int. Cl. H04J 11/00; H04Q 7/00

(52) U.S. Cl. 370/204; 370/329

(57) ABSTRACT

An apparatus and method for communicating control information in a Broadband Wireless Access (BWA) system using a multi-hop relay scheme is provided. A method of transmitting control information includes generating scheduling information by performing scheduling for a Relay Station (RS); determining a valid duration for the scheduling information; generating a resource allocation message containing the scheduling information and the valid duration information; and processing the resource allocation message in a physical layer and for transmitting the resource allocation message to the RS.

### PRIORITY

This application claims priority under 35 U.S.C. § 119(a) to an application filed in the Korean Intellectual Property Office on Oct. 20, 2006 and assigned Serial No. 2006-0102471, the entire disclosure of which is hereby incorporated by reference.

### BACKGROUND OF THE INVENTION

1. Field of the Invention

The present invention relates generally to an apparatus and method for communicating control information in a Broadband Wireless Access (BWA) system. In particular, the present invention relates to an apparatus and method for communicating resource allocation information for a Relay Station (RS) in a BWA system using a multi-hop relay scheme.

2. Description of the Related Art

Many wireless communication techniques are being proposed to achieve high-speed mobile communication. Among them, an Orthogonal Frequency Division Multiplexing (OFDM) scheme is accepted as one of the most promising techniques for a next generation wireless communication. The OFDM scheme is expected to be widely used in the next generation wireless communication system, and is currently used as a standard in the Institute of Electrical and Electronics Engineers (IEEE) 802.16 based Wireless Metropolitan Area Network (WMAN) known as the 3.5 generation technology, which standard is hereby incorporated by reference.

To facilitate flexible allocation of UpLink (UL)/DownLink (DL) resources in an OFDM based Broadband Wireless Access (BWA) system, a Base Station (BS) transmits UL/DL resource allocation information for every frame. For this purpose, a MAP message is used in an IEEE 802.16 based system.

FIG. 1 illustrates a frame structure of an IEEE 802.16 based system.

The frame of FIG. 1 includes a DL frame and an UL frame. The DL frame is defined as a time period in which data is transmitted from a BS to a plurality of Mobile Stations (MSs). The UL frame is defined as a time period in which data is transmitted from a plurality of MSs to a BS in a predetermined area.

The DL frame (or DL access zone) includes a preamble, a Frame Control Header (FCH), a DL MAP, an UL MAP, and a plurality of DL data bursts. The UL frame includes a control region and an UL data burst region. The DL preamble is used when the MS obtains initial synchronization and searches for a cell. The FCH contains information indicating a basic structure of the frame. The DL MAP contains Information Elements (IEs) for indicating DL data burst regions. The UL MAP contains IEs for indicating an UL frame structure.

The UL frame (or UL access zone) includes a ranging region and a plurality of UL data bursts. The ranging region is defined as a region in which an MS can transmit a code without a BS assigned for the MS. The ranging region is used to perform an initial network access, to request a handoff, to request resource allocation, and so on.

As described above, the MAP message containing the resource allocation information is transmitted for every frame. This is because a plurality of MSs having mobility exists within a cell. Since a channel state of each MS changes from moment to moment, a BS has to perform resource-scheduling with respect to each MS for every frame, and the result has to be reported for every frame.

The MS receives the DL MAP and the UL MAP transmitted from the BS for every frame, and thus recognizes the frame structure and allocation information. The IEs constituting the MAP correspond to data bursts. Table 1 shows DL-MAP IEs. Table 2 shows UL-MAP IEs. Details of respective fields described in Tables 1 and 2 are disclosed in the IEEE 802.16 standard, thus details thereof will be omitted.

TABLE 1

| Field | Size (bit) |
|---|---|
| DIUC | 4 |
| N_CID | 8 |
| (as many as N) CIDs | 16 * N |
| OFDMA symbol offset | 8 |
| Sub-channel offset | 6 |
| boosting | 3 |
| No. OFDMA symbols | 7 |
| No. Sub-channels | 6 |
| repetition coding indication | 2 |

TABLE 2

| Field | Size (bit) |
|---|---|
| CID | 16 |
| UIUC | 4 |
| if UIUC == 12 | |
| OFDMA symbol offset | 8 |
| Sub-channel offset | 7 |
| No. OFDMA symbols | 7 |
| No. Sub-channels | 7 |
| Ranging Method | 2 |
| reserved | 1 |
| if UIUC == 14 | |
| CDMA_Allocation_IE | 32 |
| If UIUC == 15 | |
| Extended UIUC dependent IE | Variable |
| else | |
| Duration | 10 |
| repetition coding indication | 2 |

In the aforementioned frame structure, a basic unit of data transmission is a sub-channel in a frequency domain and a symbol in a time domain. As described above, in the OFDM based BWA system, a DL burst and an UL burst in a frame can be allocated to at least one sub-channel and one OFDM symbol, and thus the frame structure can be flexibly formed with minimum restrictions. However, to minimize the restriction in the forming the frame structure, the size of control information to be transmitted increases. Thus, when one frame includes data of multi-users, the control information, which is reported to the users by using the DL-MAP and UL-MAP, becomes a serious overhead.

Meanwhile, a next generation mobile communication system that operates in a high frequency region experiences constraint in a throughput and a service coverage due to a high path loss. To address such problems, research on a multi-hop based signal transmission method is being conducted in recent years. According to the multi-hop based technique, a path loss can be reduced when a Relay Station (RS) is used to relay data. Furthermore, a signal can be transmitted to an MS located far away from a BS.

The RS can be classified into a fixed RS having a low mobility, a nomadic RS (e.g., laptop computer) having a nomadic feature, and a mobile RS having the same mobility as an MS. When using the fixed RS or the nomadic RS of which a channel state does not significantly change, there is no need to perform scheduling for every frame as in the case of the MS. In other words, new resource allocation is not necessary for every frame when the channel state does not change.

As described above, control information (i.e., DL-MAP/UL-MAP) transmitted through a control channel in a BWA system acts as a serious overhead. A size of the control information transmitted through the control channel may be significantly reduced if resource scheduling is carried out with respect to an RS for a long period of time instead of for every frame.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for reducing a control information size in a Broadband Wireless Access (BWA) system using a multi-hop relay scheme.

Another aspect of the present invention is to provide an apparatus and method in which scheduling is carried out for a long time period with respect to a Relay Station (RS), of which a channel state does not significantly change, in a BWA system using a multi-hop relay scheme.

Another aspect of the present invention is to provide an apparatus and method for communicating a resource allocation message, which indicates a valid duration of scheduling information in a BWA system using a multi-hop relay scheme.

According to an aspect of the present invention, an apparatus for transmitting control information in a BWA system using a relay scheme is provided. The apparatus includes a scheduler for generating scheduling information by performing scheduling for an RS and for determining a valid duration for the scheduling information; a control information generator for generating a resource allocation message containing the scheduling information and the valid duration information; and a transmitter for processing the resource allocation message in a physical layer and for transmitting the resource allocation message to the RS.

According to another aspect of the present invention, a RS apparatus in a BWA system using a relay scheme is provided. The apparatus includes a receiver for receiving a resource allocation message from a Base Station (BS) or an upper layer RS; a control information reader for reading the resource allocation message and for obtaining scheduling information and information on a valid duration for the scheduling information; a memory for storing the scheduling information and the valid duration information; and a controller for controlling communication with the BS or the upper layer RS by using the scheduling information during the valid duration.

According to another aspect of the present invention, a method of transmitting control information in a BWA system using a relay scheme is provided. The method includes generating scheduling information by performing scheduling for a RS; determining a valid duration for the scheduling information; generating a resource allocation message containing the scheduling information and the valid duration information; and processing the resource allocation message in a physical layer and for transmitting the resource allocation message to the RS.

According to another aspect of the present invention, a communication method of a RS in a BWA system using a relay scheme is provided. The method includes receiving a resource allocation message from a BS or an upper layer RS; reading the resource allocation message and obtaining scheduling information and information on a valid duration for the scheduling information; storing the scheduling information and the valid duration information; and performing communication with the BS or the upper layer RS by using the scheduling information during the valid duration.

### BRIEF DESCRIPTION OF THE DRAWINGS

The above and other objects, aspects, features and advantages of certain exemplary embodiments of the present invention will become more apparent from the following detailed description when taken in conjunction with the accompanying drawings, in which:

FIG. 1 illustrates a frame structure of a system based on the Institute of Electrical and Electronics Engineers (IEEE) 802.16 standards;

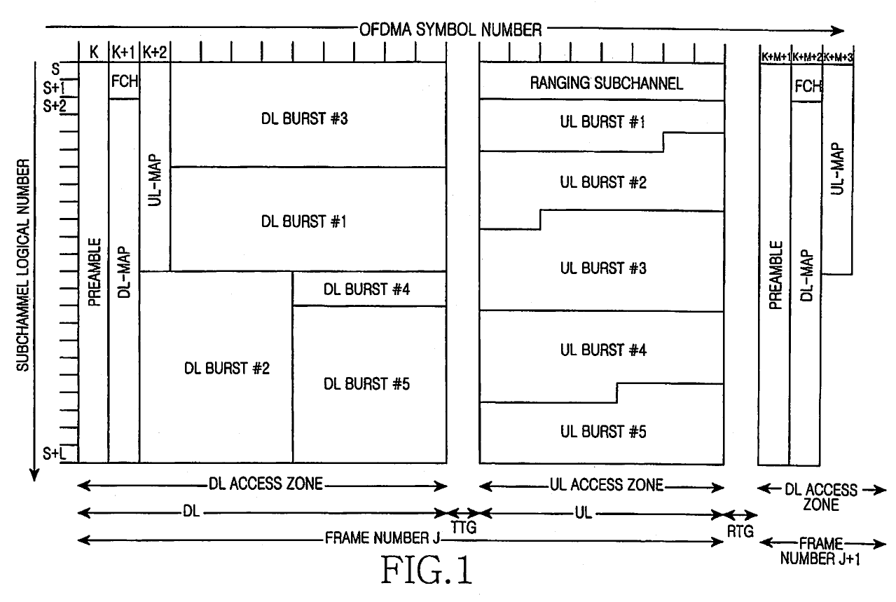

FIG. 2 is a schematic view illustrating a structure of a system using a multi-hop relay scheme;

FIG. 3 illustrates a frame structure of a Base Station (BS) in a 2-hop situation in a Broadband Wireless Access (BWA) system using a multi-hop relay scheme according to the present invention;

FIG. 4 is a block diagram illustrating a structure of a transmitter in a BWA system according to the present invention;

FIG. 5 is a block diagram illustrating a structure of a receiver in a BWA system according to the present invention;

FIG. 6 is a flowchart illustrating an operation of a transmitter in a BWA system according to the present invention; and

FIG. 7 is a flowchart illustrating an operation of a Relay Station (RS) in a BWA system according to the present invention.

### DETAILED DESCRIPTION OF THE PREFERRED EMBODIMENTS

The following description with reference to the accompanying drawings is provided to assist in a comprehensive understanding of exemplary embodiments of the present invention as defined by the claims and their equivalents. Accordingly, those of ordinary skill in the art will recognize that various changes and modifications of the embodiments described herein can be made without departing from the scope and spirit of the invention. Also, descriptions of well-known functions and constructions will be omitted for clarity and conciseness.

A technique for reducing a size of control information that is broadcast from a Broadband Wireless Access (BWA) system using a multi-hop relay scheme will be described below.

The multi-hop relay scheme used in the BWA system may be either an Orthogonal Frequency Division Multiplexing (OFDM) scheme or an Orthogonal Frequency Division Multiple Access (OFDMA) scheme. Although the BWA is described below, this is for exemplary purposes only. Thus, the present invention may also be applied to a cellular-based communication system using the multi-hop relay scheme.

A Relay Station (RS) can be classified into a fixed RS having a low mobility, a nomadic RS (e.g., laptop computer) having a nomadic feature, and a mobile RS having the same mobility as a Mobile Station (MS).

According to the present invention, regarding an RS, such as the fixed RS or the nomadic RS, of which a channel state does not significantly change, scheduling is performed for a long period of time rather than for every frame, and communication is achieved by allowing a resource allocation message (i.e., MAP Information Element (IE)) to indicate a value duration of an allocation resource. When the resource allocation message is intermittently transmitted to the RS, a size of control information (i.e., MAP information) contained in a limited frame can be remarkably reduced.

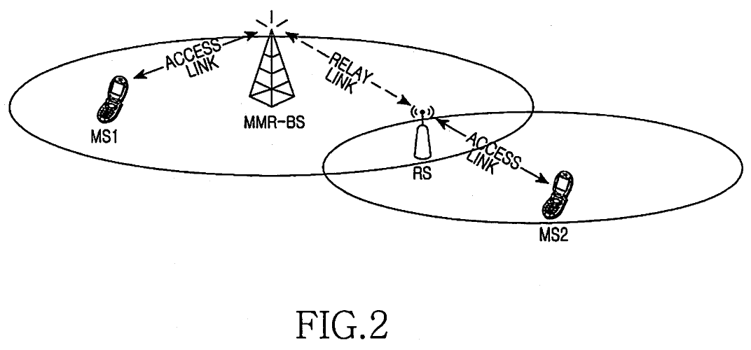

FIG. 2 is a schematic view illustrating a structure of a system using a multi-hop relay scheme. Referring to FIG. 2, an MS1 is located in a service coverage area of a Mobile Multi-hop Relay (MMR)-Base Station (BS) and is directly linked to the MMR-BS. MS2 is located outside the service coverage area of the MMR-BS and thus is linked to the MMR-BS via an RS. As such, the RS is located between the MMR-BS and the MS2 so that data transmitted from the MMR-RS is relayed to the MS2 and data transmitted from the MS2 is relayed to the MMR-RS. A link between the MMR-BS and the MS1 or between the RS and the MS2 is defined as an access link. A link between the MMR-BS and the RS is defined as a relay link.

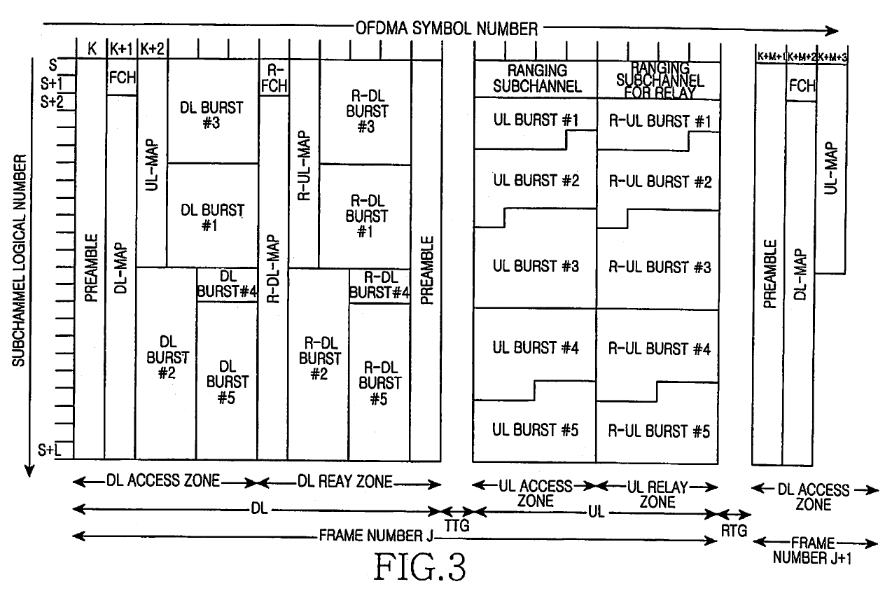

FIG. 3 illustrates a frame structure of a BS in a 2-hop situation in a BWA system using a multi-hop relay scheme according to an embodiment of the present invention.

Referring to FIG. 3, a DL frame includes a DL access zone and a DL relay zone. In the DL access zone, a service is provided to an MS (e.g., the MS1 of FIG. 2) directly connected to a BS. In the DL relay zone, a service is provided to an RS (e.g., the RS of FIG. 2) connected to the BS. A DL/UL-MAP transmitted in the DL access zone, that is, a MAP message transmitted to the MS, may be a predefined message as described in Tables 1 and 2 above.

According to the present invention, the R-DL-MAP/R-UL-MAP transmitted in the DL relay zone, that is, a MAP message transmitted to an RS, contains a field indicating a valid duration of an allocation resource (i.e., scheduling information). The MAP message can be intermittently delivered by allowing the MAP message to indicate the valid duration of the allocation resource for the RS. When using the multi-hop scheme and when data is transmitted to a next hop RS, the MAP message indicates the valid duration of the allocation resource for the RS as in the case of the 2-hop situation.

The following fields are appended to the R-DL/UL MAP message according to the present invention, as described in Table 3 and Table 7.

TABLE 3

| Syntax | Size | Note |
|---|---|---|
| Frame | xxx bit | information indicating the number of frames during |
| duration | | which scheduling information is maintained |

TABLE 4

| Syntax | Size | Note |
|---|---|---|
| Duration end | xxx bit | information indicating an n^{th} frame number |
| frame number | | until which scheduling information |
| | | is maintained |

TABLE 5

| Syntax | Size | Note |
|---|---|---|
| Periodic | xxx bit | information indicating that scheduling |
| allocation frame | | information is allocated for |
| number P | | every 2^{P} period |

Information described in Table 5 may be used together with Table 3 or Table 4. In this case, during a valid duration, the scheduling information is allocated for every 2^{P} period.

TABLE 6

| Syntax | Size | Note |
|---|---|---|
| Non-periodic | xxx bit | information indicating whether to |
| allocation frame | | use scheduling information regarding |
| bit map | | respective frames by using a bit map |
| | | (this MAP information is used when the bit |
| | | map is 1, and another MAP information is |
| | | used when the bit map is 0) when MAP |
| | | is used non-periodically until a frame |
| | | duration or a duration end frame is over |

The information described in Table 6 is used together with Table 3 or Table 4. This information is used when scheduling information is non-periodically performed.

TABLE 7

| Syntax | Size | Note |
|---|---|---|
| MAP | xxx bit | information indicating which MAP indication type |
| indication | | will be used among various MAP indication types |
| type | | |

Information described in Table 7 shows a valid duration indication type of scheduling information. According to a predetermined indication type, a BS (or RS) allows the MAP message to contain at least one of information pieces described in Tables 4 to 6.

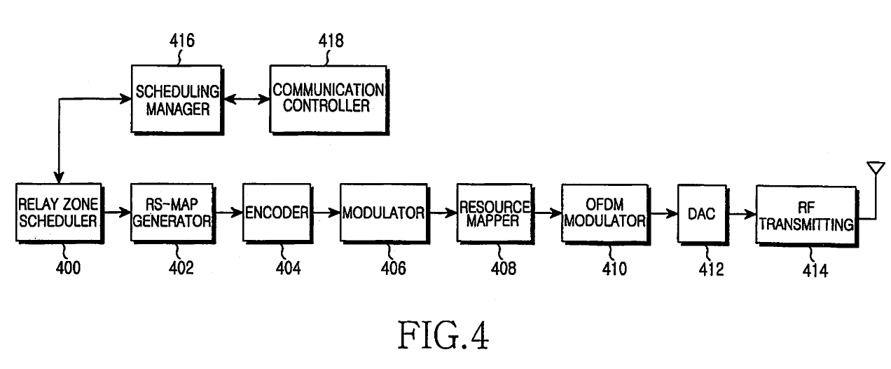

FIG. 4 is a block diagram illustrating a structure of a transmitter in a BWA system according to an embodiment of the present invention. Referring to FIG. 4, the transmitter includes a relay zone scheduler 400, a RS-MAP generator 402, an encoder 404, a modulator 406, a resource mapper 408, an OFDM modulator 410, a Digital to Analog Converter (DAC) 412, a Radio Frequency (RF) transmitting unit 414, a scheduling manager 416, and a communication controller 418. The transmitter may be a BS (or an upper-layer RS) which broadcasts RS-MAP information.

The relay zone scheduler 400 performs resource-scheduling for a relay zone by using channel information (i.e., Channel Quality Indicator (CQI) information) reported from RSs. Further, for scheduling information (i.e., resource allocation information, control information, etc.) on each RS, the relay zone scheduler 400 determines a valid duration for the scheduling information and a specific time period for using the scheduling information and provides the determination result to the RS-MAP generator 402.

According to information received from the relay zone scheduler 400, the RS-MAP generator 402 generates MAP IEs to be transmitted to each RS. Further, the RS-MAP generator 402 generates MAP messages (i.e., DL MAP/UL MAP) by combining the MAP IEs. As described in Tables 3 to 7 above, each MAP IE may include at least one element selected from a group consisting of a valid duration of scheduling information, a specific time period in which the scheduling information is actually used during the valid duration, and information on frames in which the scheduling information is actually used. As described in Tables 1 and 2 above, the scheduling information may be selected from a group consisting of an OFDMA symbol offset for a corresponding burst, a sub-channel offset, boosting information, the number of OFDMA symbols, the number of sub-channels, and a repetition coding indication.

The encoder 404 encodes an information bit stream received from the RS-MAP generator 402 and thus generates encoded symbols. The encoder 404 may use a Convolutional Code (CC), a Block Turbo Code (BTC), a Convolutional Turbo Code (CTC), Zero Tailing Convolutional Code (ZT-CC), and so on.

The modulator 406 modulates the encoded symbols received from the encoders 404. The modulator 406 may use various modulation schemes such as Quadrature Phase Shift Keying (QPSK), 16 Quadrature Amplitude Modulation (QAM), 32QAM, and so on.

The resource mapper 408 receives data from the modulator 406 and maps the data to a predetermined resource (e.g., a head portion of a frame). The OFDM modulator 410 OFDM-modulates the resource-mapped data received from the resource mapper 408, thereby generating OFDM symbols. The OFDM modulation includes Inverse Fast Fourier Transform (IFFT) and Cyclic Prefix (CP) insertion.

The DAC 412 converts sample data received from the OFDM modulator 410 into an analog signal. The RF transmitting unit 414 converts a baseband signal received from the DAC 412 into an RF signal and transmits the RF signal through an antenna. In this manner, an RS-MAP message (or RS-MAP burst) is transmitted to a plurality of RSs. According to the RS-MAP message, forward data is received from a BS (or upper-layer RS), and backward data is transmitted to the BS (or upper-layer RS).

The scheduling information is generated by the relay zone scheduler 400 and is managed by the scheduling manager 416. The communication controller 418 evaluates a valid duration for the scheduling information managed by the scheduling manager 416 and controls communication by using the scheduling information during the valid duration. For example, under the control of the communication controller 418, a DL burst is transmitted after being mapped to a corresponding resource (or region) according to the scheduling information, and an UL burst is received by using the resource.

Although a time point at which the RS-MAP IE is transmitted is not mentioned in the above description, it is possible to generate and transmit a new MAP IE if an event (e.g., changes in a geographical environment of an RS) is generated whereby a predetermined time period or a channel state of an RS can be modified.

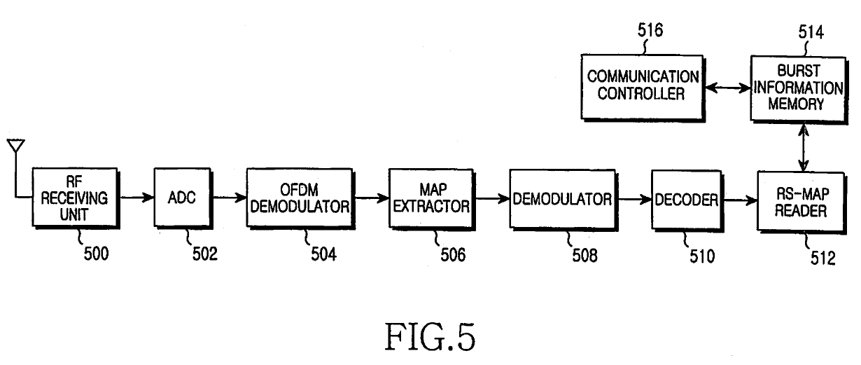

FIG. 5 is a block diagram illustrating a structure of a receiver in a BWA system according to an embodiment of the present invention. Referring to FIG. 5, the receiver includes an RF receiving unit 500, an Analog to Digital Converter (ADC) 502, an OFDM demodulator 504, a MAP extractor 506, a demodulator 508, a decoder 510, a RS-MAP reader 512, a burst information memory 514, and a communication controller 516. The receiver may be a RS which receives a RS-MAP message from a BS (or an upper-layer RS).

The RF receiving unit 500 converts an RF signal received from the BS into a baseband signal. The ADC 502 converts a baseband analog signal received from the RF receiving unit 500 into digital sample data. The OFDM demodulator 504 OFDM-demodulates the sample data received from the ADC 502 and thus outputs sub-carrier values. The OFDM demodulation includes CP removal and Fast Fourier Transform (FFT).

The MAP extractor 506 extracts an RS-MAP burst, which is received in a predetermined region in a frame, from data received from the OFDM demodulator 504. The demodulator 508 demodulates data received from the MAP extractor 506 according to a predetermined demodulation method. The decoder 510 decodes data received from the demodulator 508, thereby restoring the RS-MAP message. In this case, the decoder 510 performs CRC on the restored MAP message. If the CRC is successful, the decoder 510 provides the RS-MAP message to the RS-MAP reader 512.

The RS-MAP reader 512 reads the RS-MAP message received from the decoder 510. According to the present invention, the RS-MAP reader 512 determines whether a MAP IE for the RS-MAP reader 512 is included in the MAP message. When the MAP IE is included, the RS-MAP reader 512 extracts burst information (i.e., scheduling information) from the received MAP IE and stores the burst information in the burst information memory 514. As described in Tables 3 to 7 above, each MAP IE may include at least one element selected from a group consisting of a valid duration of scheduling information, a specific time period in which the scheduling information is actually used during the valid duration, and information on frames in which the scheduling information is actually used. As described in Tables 1 and 2 above, the scheduling information may be selected from a group consisting of an OFDMA symbol offset for a corresponding burst, a sub-channel offset, boosting information, the number of OFDMA symbols, the number of sub-channels, and a repetition coding indication.

The communication controller 516 controls overall operations of DL communication and UL communication by using the DL/UL burst information stored in the burst information memory 514. For example, under the control of the communication controller 516, the DL burst may be received by using a corresponding resource (or region) according to the DL burst information, and the UL burst may be transmitted by using the resource according to the UL burst information.

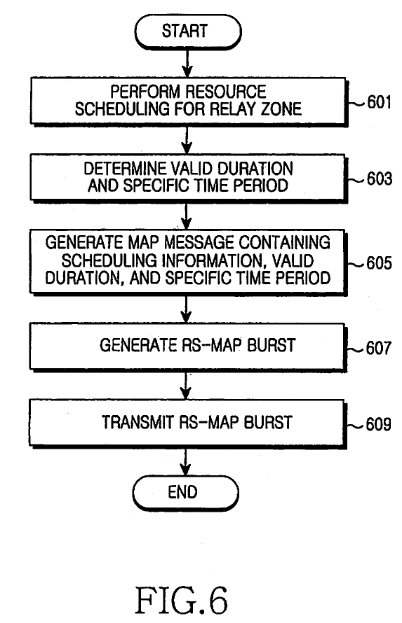

FIG. 6 is a flowchart illustrating an operation of a transmitter in a BWA system according to an embodiment of the present invention. The transmitter may be either a BS or an RS. It will be assumed hereinafter that the transmitter is the BS. Referring to FIG. 6, in step 601, resource scheduling is performed for a DL relay zone/UL relay zone. Upon completing the resource scheduling, in step 603, a valid duration and a specific time period are determined with respect to scheduling information on respective RSs. The valid duration is defined as a time period in which the scheduling information is valid. The specific time period is defined as a time period in which the scheduling information is actually used during the valid duration. When the scheduling information is non-periodically used, a bitmap is determined to identify frames in which the scheduling information is used as described in Table 6 above.

Upon determining the valid duration and the specific time period for each RS (or RS burst), in step 605, a MAP IE containing the scheduling information, the valid duration, and the specific time period is generated for each RS. As described in Tables 3 to 7 above, each MAP IE may include at least one element selected from a group consisting of a valid duration of scheduling information, a specific time period in which the scheduling information is actually used during the valid duration, and information on frames in which the scheduling information is actually used. As described in Tables 1 and 2 above, the scheduling information may be selected from a group consisting of an OFDMA symbol offset for a corresponding burst, a sub-channel offset, boosting information, the number of OFDMA symbols, the number of sub-channels, and a repetition coding indication.

In step 607, the MAP IEs of the RSs are collected to form an RS-MAP message. In step 609, the RS-MAP message is manipulated according to a predetermined rule and the resultant RS-MAP message is broadcast. Thereafter, according to information contained in the RS-MAP message, R-DL bursts are transmitted, and R-UL bursts are received. If a specific event does not occur until the valid duration is over with respect to an arbitrary RS, the BS does not transmit the MAP IE. The specific event occurs when a resource allocated to the RS is inevitably changed, for example, a channel state is changed along with changes in a geographical environment of the RS.

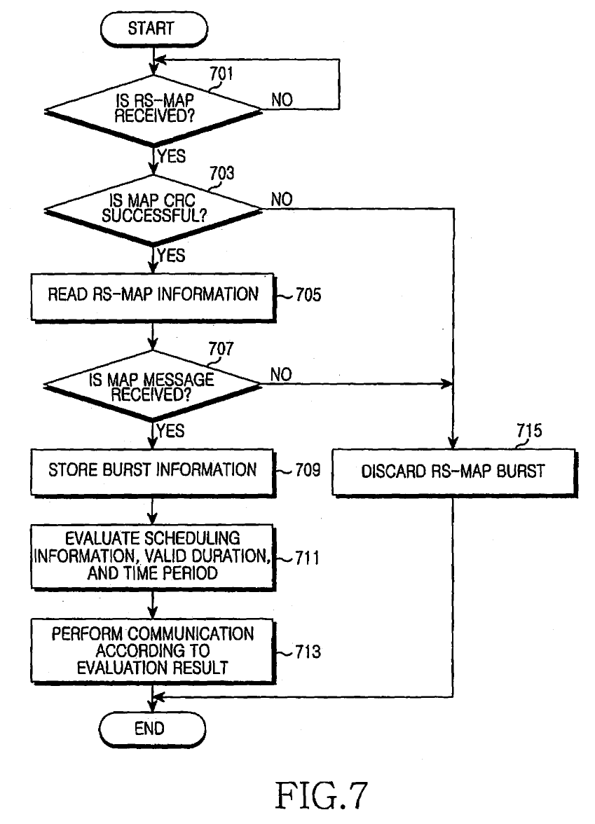

FIG. 7 is a flowchart illustrating an operation of a RS in a BWA system according to an embodiment of the present invention. Referring to FIG. 7, in step 701, it is determined whether a RS-MAP burst (or RS-MAP message) is received. Upon receiving the RS-MAP burst, in step 703, a CRC code of the received RS-MAP burst is checked to determine whether the CRC code is correct. When the CRC code is determined to be incorrect, the procedure proceeds to step 715, and thus the received RS-MAP burst is discarded.

When the CRC code is determined to be correct, the procedure proceeds to step 705, and thus MAP IEs of the RS-MAP burst are sequentially read. In step 707, identifiers (e.g., CID) of the MAP IEs are evaluated to determine the presence of an MAP IE for the RS.

When the MAP IE for the RS is not detected, the procedure proceeds to step 715, and thus the received RS-MAP burst is discarded. Otherwise, the procedure proceeds to step 709, and thus information of a burst (i.e., R-DL burst/R-UL burst) allocated to the RS is extracted from the MAP message, and the burst information is stored. Examples of the stored burst information include scheduling information, a valid duration for the scheduling information, and a specific time period in which the scheduling information is actually used during the valid duration (or information, i.e., bitmap information, on frames in which the scheduling information is used). Examples of the scheduling information may include an OFDMA symbol offset for a corresponding burst, a sub-channel offset, boosting information, the number of OFDMA symbols, the number of sub-channels, and a repetition coding indication.

In step 711, the stored burst information (e.g., the scheduling information, the valid duration, the specific time period, etc.) is evaluated. In step 713, according to the evaluation result, communication with a BS (or an upper-layer RS) is made. Communication is achieved by maintaining the scheduling information during the valid duration and by using the scheduling information according to the specific time period.

As described above, the present invention has an advantage with respect to an RS (either a fixed RS or a nomadic RS), of which a channel states changes not significantly, overhead can be reduced by performing scheduling for a long period of time instead of for every frame. A BS allocates a resource to the RS by performing scheduling according to a predetermined time period and transmits a MAP IE in which a valid duration of the allocated resource is indicated. Thus, overhead generated when the MAP IE is transmitted for every frame can be removed. The present invention has an advantage in that a size of control information (MAP burst) can be significantly reduced by intermittently transmitting the MAP IE for the RS. The reduction of the MAP burst (R-MAP message) size results in the increase of an actual traffic zone, which advantageously leads to the increase of a system cell capacity.

While the invention has been shown and described with reference to certain exemplary embodiments thereof, it will be understood by those skilled in the art that various changes in form and details may be made therein without departing from the spirit and scope of the invention as defined by the appended claims and their equivalents. Although a MAP message for an RS has been described in the exemplary embodiments, a MAP message for an MS may also be formed in the same manner. For example, a MAP message may be generated as described above when a Voice over Internet Protocol (VoIP) service is used in which packets are periodically generated.

Therefore, the scope of the invention is defined not by the detailed description of the invention but by the appended claims and their equivalents, and all differences within the scope will be construed as being included in the present invention.

What is claimed is:

1. An apparatus for transmitting control information in a Broadband Wireless Access (BWA) system using a relay scheme, the apparatus comprising:
a scheduler for generating scheduling information by performing scheduling for a Relay Station (RS) and for determining a valid duration for the scheduling information;
a control information generator for generating a resource allocation message containing the scheduling information and the valid duration information; and
a transmitter for processing the resource allocation message in a physical layer and for transmitting the resource allocation message to the RS.

2. The apparatus of claim 1, wherein the scheduling information comprises at least one item selected from a group consisting of an Orthogonal Frequency Division Multiple Access (OFDMA) symbol offset, a sub-channel offset, boosting information, the number of OFDMA symbols, the number of sub-channels, and a repetition coding indicator.

3. The apparatus of claim 1, wherein the resource allocation message comprises at least one item selected from a group consisting of the scheduling information, information on the valid duration for the scheduling information, information on a specific time period in which the scheduling information is actually used during the valid duration, and information on frames in which the scheduling information is actually used during the valid duration.

4. The apparatus of claim 1, wherein, for every time period including at least one frame, the control information generator periodically generates a MAP Information Element (IE) to be transmitted to the RS according to the valid duration.

5. The apparatus of claim 1, further comprising a controller for controlling communication with the RS by using the scheduling information during the valid duration.

6. The apparatus of claim 1, wherein, for every time period including at least one frame, the scheduler periodically performs scheduling for the RS.

7. The apparatus of claim 1, wherein the scheduler generates new scheduling information by performing scheduling for the RS and determines a valid duration for the new scheduling information.

8. The apparatus of claim 1, wherein the transmitter comprises:
an encoder for encoding control information received from the control information generator;
a modulator for modulating data received from the encoder;
a resource mapper for mapping data received from the modulator to a predetermined resource;
an Orthogonal Frequency Division Multiplexing (OFDM) modulator for OFDM-modulating resource-mapped data received from the resource mapper; and
a Radio Frequency (RF) transmitter for converting data received from the OFDM modulator into an RF signal.

9. A Relay Station (RS) apparatus in a Broadband Wireless Access (BWA) system using a relay scheme, the apparatus comprising:
a receiver for receiving a resource allocation message from one of a Base Station (BS) and an upper layer RS;
a control information reader for reading the resource allocation message and for obtaining scheduling information and information on a valid duration for the scheduling information;
a memory for storing the scheduling information and the valid duration information; and
a controller for controlling communication with one of the BS and the upper layer RS by using the scheduling information during the valid duration.

10. The apparatus of claim 9, wherein the scheduling information comprises at least one item selected from a group consisting of an Orthogonal Frequency Division Multiple Access (OFDMA) symbol offset, a sub-channel offset, boosting information, the number of OFDMA symbols, the number of sub-channels, and a repetition coding indicator.

11. The apparatus of claim 9, wherein the resource allocation message comprises at least one item selected from a group consisting of the scheduling information, the information on the valid duration for the scheduling information, information on a specific time period in which the scheduling information is actually used during the valid duration, and information on frames in which the scheduling information is actually used during the valid duration.

12. The apparatus of claim 9, wherein the resource allocation message is periodically received for every time period including at least one frame according to the valid duration.

13. A method of transmitting control information in a Broadband Wireless Access (BWA) system using a relay scheme, the method comprising the steps of:
generating scheduling information by performing scheduling for a Relay Station (RS);
determining a valid duration for the scheduling information;
generating a resource allocation message containing the scheduling information and the valid duration information; and
transmitting the resource allocation message to the RS.

14. The method of claim 13, wherein the scheduling information comprises at least one item selected from a group consisting of an Orthogonal Frequency Division Multiple Access (OFDMA) symbol offset, a sub-channel offset, boosting information, the number of OFDMA symbols, the number of sub-channels, and a repetition coding indicator.

15. The method of claim 13, wherein the resource allocation message comprises at least one item selected from a group consisting of the scheduling information, information on the valid duration for the scheduling information, information on a specific time period in which the scheduling information is actually used during the valid duration, and information on frames in which the scheduling information is actually used during the valid duration.

16. The method of claim 13, wherein the resource allocation message for the RS is periodically transmitted for every time period including at least one frame.

17. The method of claim 13, further comprising performing communication with the RS by using the scheduling information during the valid duration.

18. The method of claim 13, wherein the scheduling for the RS is performed for every time period including at least one frame according to the valid duration.

19. The method of claim 13, further comprising generating new scheduling information by performing scheduling for the RS and determining a valid duration for the new scheduling information.

20. The method of claim 13, wherein the step of transmitting the resource allocation message comprises:
encoding and modulating the resource allocation message;
mapping the modulated data to a predetermined resource and performing Orthogonal Frequency Division Multiplexing (OFDM)-modulation on the mapped data; and
converting the OFDM-modulated data into a Radio Frequency (RF) signal.

21. A communication method of a Relay Station (RS) in a Broadband Wireless Access (BWA) system using a relay scheme, the method comprising the steps of:
receiving a resource allocation message from one of a Base Station (BS) and an upper layer RS;
reading the resource allocation message and obtaining scheduling information and information on a valid duration for the scheduling information;
storing the scheduling information and the valid duration information; and
performing communication with one of the BS and the upper layer RS by using the scheduling information during the valid duration.

22. The method of claim 21, wherein the scheduling information comprises at least one item selected from a group consisting of an Orthogonal Frequency Division Multiple Access (OFDMA) symbol offset, a sub-channel offset, boosting information, the number of OFDMA symbols, the number of sub-channels, and a repetition coding indicator.

23. The method of claim 21, wherein the resource allocation message comprises at least one item selected from a group consisting of the scheduling information, the information on the valid duration for the scheduling information, information on a specific time period in which the scheduling information is actually used during the valid duration, and information on frames in which the scheduling information is actually used during the valid duration.

24. The method of claim 21, wherein the resource allocation message is periodically received for every time period including at least one frame according to the valid duration.
